(19) United States
(12) Patent Application Publication
(10) Pub. No.: US 2007/0263651 A1
(43) Pub. Date: Nov. 15, 2007

(54) DISTRIBUTED DSLAM ARCHITECTURE

(76) Inventors: Robert A. Novotny, Naperville, IL (US); Carl R. Posthuma, Wheaton, IL (US); Ramfis Rivera-Colon, Aurora, IL (US)

Correspondence Address: DUFT BORNSEN & FISHMAN, LLP, 1526 SPRUCE STREET, SUITE 302, BOULDER, CO, 80302, US

(21) Appl. No.: 11/382,511

(22) Filed: May 10, 2006

(51) Int. Cl. H04L 12/56

(52) U.S. Cl. 370/422

(57) ABSTRACT

DSLAMs and associated methods of installing DSLAMs are disclosed where the components of a DSLAM are distributed in a DSL network. A distributed DSLAM as provided herein includes digital signal processing components implemented in a centralized system (e.g., a central office) on the DSL network. The distributed DSLAM also includes digital/analog conversion components (e.g., analog front end (AFE) components) implemented in a distributed node on the DSL network that is remote from the centralized system. The distributed DSLAM also includes a spanned communication link (e.g., optical fiber) between the digital signal processing components and the digital/analog conversion components. The digital signal processing components in the centralized system are considered more likely to be upgraded than the digital/analog conversion components in the distributed node. Thus, upgrades for the DSLAM can frequently be performed at the centralized system instead of at the distributed node.

### BACKGROUND OF THE INVENTION

1. Field of the Invention

The invention is related to the field of communications and, in particular, to a distributed DSLAM architecture. More particularly, a DSLAM is separated by its components such that digital/analog conversion components of the DSLAM are installed in a distributed node in the network while digital signal processing and/or packet processing components of the DSLAM are installed in a centralized system.

2. Statement of the Problem

DSL technology is a platform for delivering broadband services to homes and small businesses. DSL can support a wide variety of high-bandwidth applications, such as high-speed Internet access, virtual private networking, and streaming multimedia content. DSL uses the same wires as a regular telephone line. The copper wires connected to residences (also referred to as the “local loop”) have available bandwidth for carrying more than voice conversations. DSL takes advantage of the available bandwidth by using higher frequency signals to transmit data while using the lower frequency signals to transmit voice.

DSL providers may use the existing telephone network to implement DSL service. DSL providers add a digital subscriber line access multiplexer (DSLAM) to the central office that is presently connected to the local loops of the customers. The DSLAM connects to the local loop of a plurality of customers, and connects to the Internet over a very high speed connection, such as an optical fiber, to act as an interface between the customers and the Internet. The DSLAM operates by separating the voice-frequency signals from the high-speed data traffic and controls and routes digital subscriber line (xDSL) traffic between the customers' end-user equipment (e.g., DSL modem) and the Internet.

One limitation to DSL service is the distance between the DSLAM and the customers. As the distance increases, the signal quality and connection speed decrease. Some DSL services have a maximum distance of 18,000 feet (5,460 m) between the DSLAM and the customer. Service providers may place a much lower limit on the maximum distance to ensure that guaranteed bit rates are delivered to the customers.

DSL service providers are overcoming this limitation by distributing DSLAMs in the network at locations more proximate to the customers than the central office. To distribute the DSLAMs, the service provider installs the DSLAMs in digital-loop carrier (DLC) cabinets, junction boxes, or other locations (referred to generally herein as “nodes”). The nodes connect to the central office through optical fibers, and connect to the customers over the local loops. Networks with this configuration are referred to as fiber to the neighborhood (FTTN) or fiber to the node (FTTN) networks.

FIG. 1 illustrates a typical FTTN network 100 in the prior art. Network 100 includes a central office 110 and a node 120 connected by an optical fiber 112. Node 120 also connects to a plurality of local loops 114, which in turn connect to customer premises equipment 171-175 of DSL customers. Node 120 includes a DSLAM 130 adapted to provide DSL service to the customers. DSLAM 130 includes a plurality of line cards 140-142 connected to an uplink card 150. The line cards 140-142 each connect to a plurality of local loops 114 to serve a plurality of customers. Uplink card 150 connects to optical fiber 112 to interface DSLAM 130 with the central office 110.

The components of line card 140 are illustrated in FIG. 1, and line cards 141-142 have similar configurations. Line card 140 includes protection components (PROT) 144 that are adapted to protect line card 140 from voltage spikes, such as from lightning, inadvertent contact with power cables, etc. Line card 140 also includes analog front end (AFE) components 145 that are adapted to provide analog to digital conversion for signals coming from the customer (upstream), and to provide digital to analog conversion for signals going to the customer (downstream). Line card 140 also includes digital signal processing (DSP) components 146 that are adapted to provide any type of desired signal processing to the downstream digital signals or upstream digital signals. For instance, the digital signal processing may include compression/decompression of the digital signals, interpolation/decimation, QAM modulation/demodulation, framing such as FEC and interleaving, Layer 2 framing such as ATM or Ethernet, etc. Line card 140 also includes a network processor (NP) 147 that is adapted to provide packet processing. Network processor 147 may receive downstream packets and convert the packets to digital signals that are processed by the DSP components 146. Network processor 147 may also receive digital signals from the DSP components 146 and packetize the digital signals in a protocol used to transmit the packets. Line card 140 also includes interface components (I/F) 148 that connects line card 140 to uplink card 150 over a localized connection 149. Localized connection 149 may comprise a backplane, such as if line cards 140-142 and uplink card 150 are mounted in a rack having a conventional backplane.

Uplink card 150 includes interface components (I/F) 152 that connect uplink card 150 to line cards 140-142 over localized connection 149. Uplink card 150 also includes a network processor (NP) 154 that is adapted to process upstream packets from line cards 140-142 and downstream packets to line cards 140-142. Network processor 154 may provide any desired packet processing, such as prioritizing packets, doling out packets to the proper line card 140-142, etc. Uplink card 150 also includes an optical interface (OPT I/F) 156 adapted to interface uplink card 150 with optical fiber 112.

One problem with distributing the DSLAMs 130 in the network 100 as shown in FIG. 1 is the cost and time required for network management. Each time a service change or hardware upgrade is desired in the DSLAMs, the service provider has to deploy a technician to each of the nodes 120 of the network (sometimes referred to as a truck roll). Deploying a truck and one or more technicians to each node can be expensive, especially if the service provider has many DSLAMs installed in the remote nodes (i.e., remote from the central office). It would thus be desirable to reduce the time and expense needed for network management in networks where the DSLAMs are distributed in the network.

### SUMMARY OF THE SOLUTION

The invention solves the above and other problems by distributing components of the DSLAM in a DSL network. The components of the DSLAM that are more likely to be upgraded or changed are installed in a centralized system, such as in the central office. The components of the DSLAM that are less likely to be upgraded or changed are installed in the distributed nodes of the network. By distributing the components of the DSLAM in this manner, network management can advantageously be performed more efficiently and cheaper while still minimizing the distance between the DSLAM and the customers. As an example, digital signal processing components are frequently changed to add new DSL services or to increase performance. The digital signal processing components may be installed in the central office or another centralized system so that a truck roll is not needed to multiple different nodes of the network to upgrade the digital signal processing components in multiple DSLAMs. The DSLAMs can be upgraded by a technician in the central office.

One embodiment of the invention comprises a distributed DSLAM for a DSL network. The distributed DSLAM includes digital signal processing components implemented in a centralized system (e.g., a central office) on the DSL network. The distributed DSLAM also includes digital/analog conversion components (e.g., analog front end (AFE) components) implemented in a distributed node on the DSL network that is remote from the centralized system. The distributed DSLAM also includes a spanned communication link (e.g., an optical fiber) between the digital signal processing components and the digital/analog conversion components. The digital signal processing components in the centralized system are considered more likely to be upgraded than the digital/analog conversion components in the distributed node. Thus, upgrades for the DSLAM can frequently be performed at the centralized system instead of at the distributed nodes, which reduces the number of truck rolls being paid for by the service provider.

The invention may include other exemplary embodiments described below.

### DESCRIPTION OF THE DRAWINGS

FIG. 1 illustrates a typical FTTN network in the prior art.

FIG. 2 illustrates a DSL network in an exemplary embodiment of the invention.

FIG. 3 is a flow chart illustrating a method of implementing a distributed DSLAM for a DSL network in an exemplary embodiment of the invention.

FIG. 4 is a flow chart illustrating another method of implementing a distributed DSLAM for a DSL network in an exemplary embodiment of the invention.

FIG. 5 illustrates an FTTN DSL network in an exemplary embodiment of the invention.

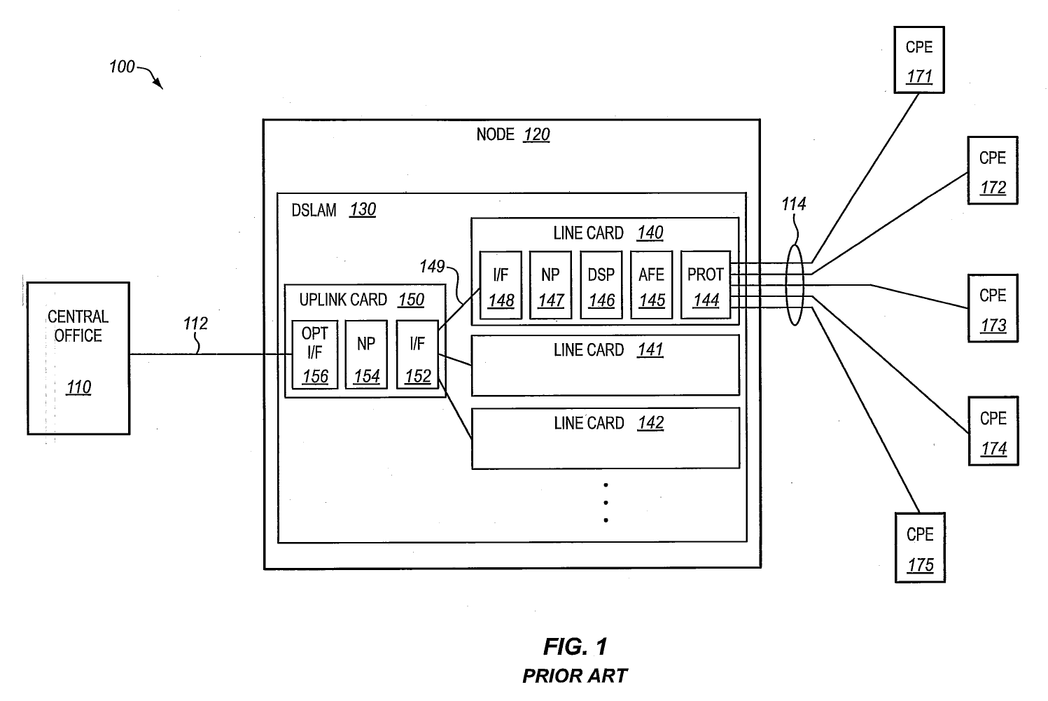

### DETAILED DESCRIPTION OF THE INVENTION

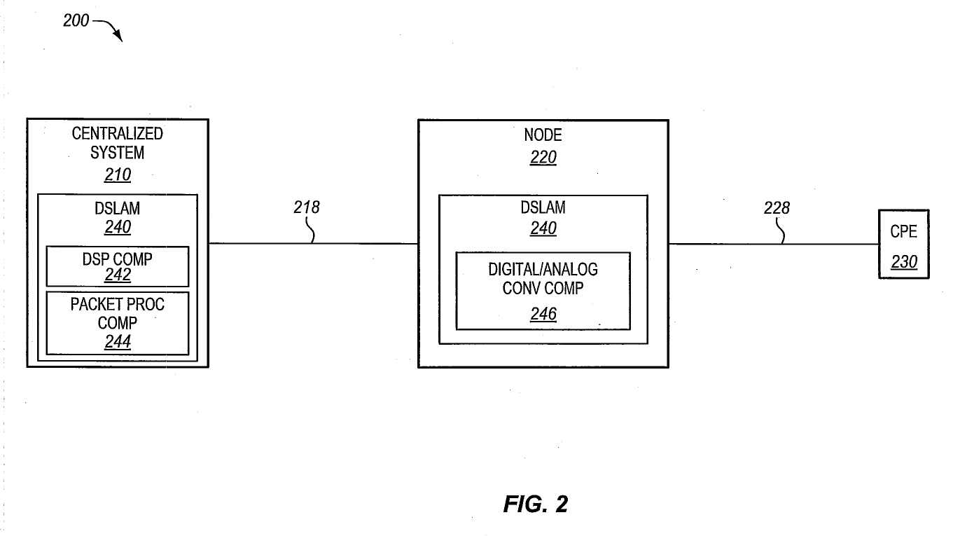

FIGS. 2-5 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 2 illustrates a DSL network 200 in an exemplary embodiment of the invention. DSL network 200 is illustrated as including a centralized system 210, a distributed node 220, and customer premises equipment (CPE) 230. In an actual implementation, DSL network 200 will include multiple distributed nodes 220 connected to centralized system 210 and will include CPE 230 from multiple customers connected to distributed node 220, but FIG. 2 has been simplified for the sake of brevity. Centralized system 210 comprises any system in a centralized location where DSL components are installed. One example of centralized system 210 includes a central office. Distributed node 220 comprises any element in the DSL network that is remote from the centralized system 210 and is generally closer in proximity to CPE 230 than is centralized system 210. Examples of node 220 include a DLC cabinet, a junction box, etc. Centralized system 210 is coupled to distributed node 220 over a spanned communication link 218. A spanned communication link 218 comprises any link used for communication over a distance, such as 1 kilometer, 2 kilometers, 3 kilometers, 20 kilometers, 50 kilometers, etc, between two remote systems. Spanned communication link 218 is not intended to be a link used between components in the same cabinet, such as a backplane, a bus, etc. Distributed node 220 is coupled to CPE 230 over a local loop 228.

DSL network 200 is adapted to provide DSL service to CPE 230. To provide the DSL service, DSL network 200 implements a distributed DSLAM 240 according to features and aspects described herein. For the distributed DSLAM 240, some DSLAM components are installed or implemented in centralized system 210 while other DSLAM components are installed or implemented in distributed node 220. Multiple DSLAMs may be implemented as described in the following paragraphs.

In this embodiment, digital signal processing components (DSP COMP) 242 are installed or implemented in centralized system 210. Digital signal processing components 242 may include one or more digital signal processors (DSP) and other associated components used for digital signal processing in a DSLAM. Digital signal processing components 242 may comprise hardware, software, and/or firmware. The digital signal processing components 242 may comprise a pool of digital signal processor (DSP) resources, wherein the DSP resources are allocated to DSL lines of the customers based on the processing needs of the DSL line.

Packet processing components (PACKET PROC COMP) 244 may additionally or alternatively be installed or implemented in centralized system 210. Packet processing components 244 may include one or more network processors and other associated components used for packet processing in a DSLAM. Packet processing components 244 may comprise hardware, software, and/or firmware.

Digital/analog conversion components (DIGITAL/ANALOG CONV COMP) 246 are installed or implemented in distributed node 220. Digital/analog conversion components 246 comprise the components adapted to convert digital signals to analog signals and/or convert analog signals to digital signals. One example of digital/analog conversion components 246 may include analog front end (AFE) components used for signal conversion in a DSLAM. Digital/analog conversion components 246 may comprise hardware, software, and/or firmware.

The location where particular components of DSLAM 240 are installed may depend on how often the components will be upgraded or changed. In providing DSL service, the components that provide digital signal processing, such as the digital signal processing components 242, are more likely to be upgraded or changed. The upgrades may be made to implement new services, to install new and improved equipment, etc. The components that process analog signals, such as the digital/analog conversion components 246, are less likely to be upgraded or changed. Digital/analog conversion is not a fast-evolving technology when compared to digital signal processing technology, and consequently changes are less frequent in the digital/analog conversion components 246 as compared to the digital signal processing components 247. Because the digital signal processing components 242 are more likely to be upgraded than the digital/analog conversion components 246, the digital signal processing components 242 are installed in the centralized system 210 while the digital/analog conversion components are installed in the distributed node 220. When upgrades are then needed or desired in the digital signal processing components 242, truck rolls to the distributed node 220 are not needed as the upgrade can be performed at the centralized system 210. Upgrades in digital/analog components 246 are hopefully infrequent which significantly reduces the number of truck rolls to node 220.

The following lists some possible upgrades to the digital signal processing components 242 that may be performed at the centralized system 210. One possible upgrade may be a change in framing parameters for Impulse Noise Protection (INP), such as changes to FEC parameters or interleaving parameters. Memory may be added to the digital signal processing components 242 to enhance these parameters in terms of increasing performance while keeping signal delay constant or lower and keeping bit rates constant or higher. Problem DSL lines could also be allocated more memory to fix problem lines while keeping bit rates up and delay down. The digital signal processing components 242 may comprise digital signal processor (DSP) resources having different processing power and/or different memory capabilities. The DSP resources with higher processing power and/or higher memory capabilities are allocated to higher bandwidth DSL lines, and the DSP resources with lower processing power and/or lower memory capabilities are allocated to lower bandwidth DSL lines. Presently this is not available as DSPs have fixed processing and fixed memory capabilities.

Another upgrade may be performance and loop monitoring parameters such as those used in developing loop management systems and Dynamic Spectrum Management (DSM) technologies. Another upgrade may be new bandplans. Another upgrade may be new loop diagnostic capabilities such as Dual Ended Loop Testing (DELT) or Single Ended Loop Testing (SELT).

Packet processing components 244 may also be upgraded at the centralized location 210. For instance, if new services such as IPTV or other video services are added to the DSL service, then the packet processing components 244 may need to be upgraded. Some of the upgrades may be software upgrades, but other upgrades may be hardware or firmware upgrades that can more efficiently be handled at the centralized system 210.

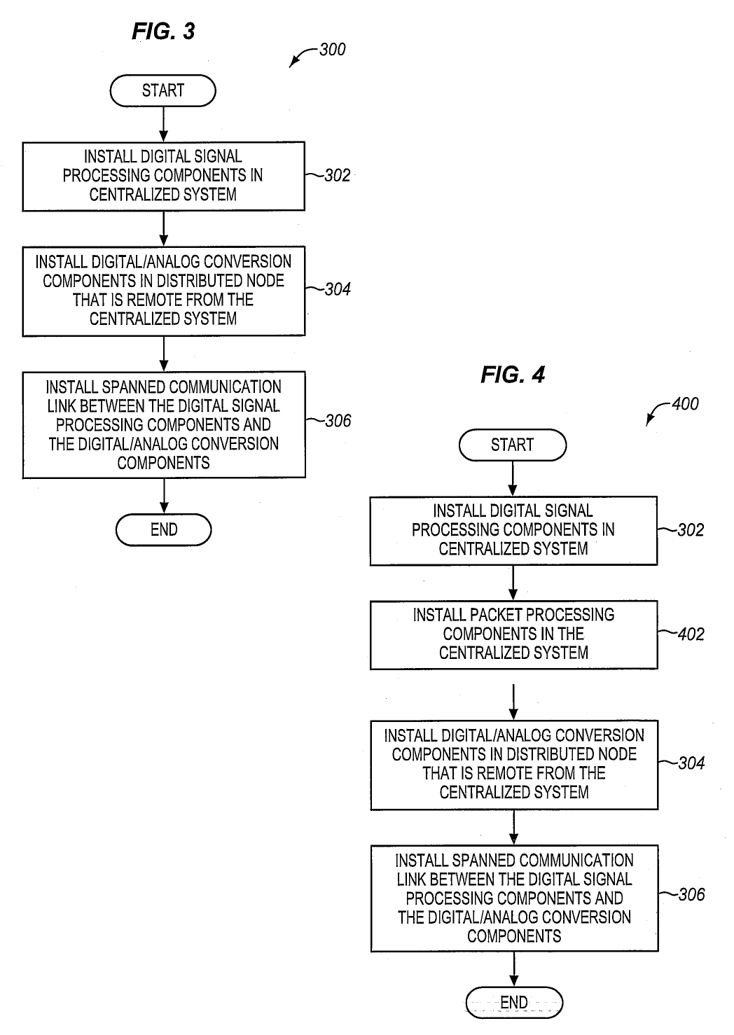

FIG. 3 is a flow chart illustrating a method 300 of implementing a distributed DSLAM for a DSL network in an exemplary embodiment of the invention. The steps of method 300 will be described with reference to DSL network 200 in FIG. 2. The steps of the flow chart in FIG. 3 are not all inclusive and may include other steps not shown.

Step 302 of method 300 includes installing digital signal processing components 242 of the distributed DSLAM 240 in centralized system 210 on the DSL network 200. Step 304 includes installing digital/analog conversion components 246 of the distributed DSLAM 240 in a distributed node 220 on the DSL network 200 that is remote from the centralized system 210. Step 306 includes installing a spanned communication link 218 between the digital signal processing components 242 and the digital/analog conversion components 246. Method 300 may be repeated to install multiple distributed DSLAMs in the DSL network 200.

FIG. 4 is a flow chart illustrating another method 400 of implementing a distributed DSLAM for a DSL network in an exemplary embodiment of the invention. Method 400 is substantially similar to method 300, but includes the further step 402 of installing packet processing components 244 in the centralized system 210 on the DSL network 200.

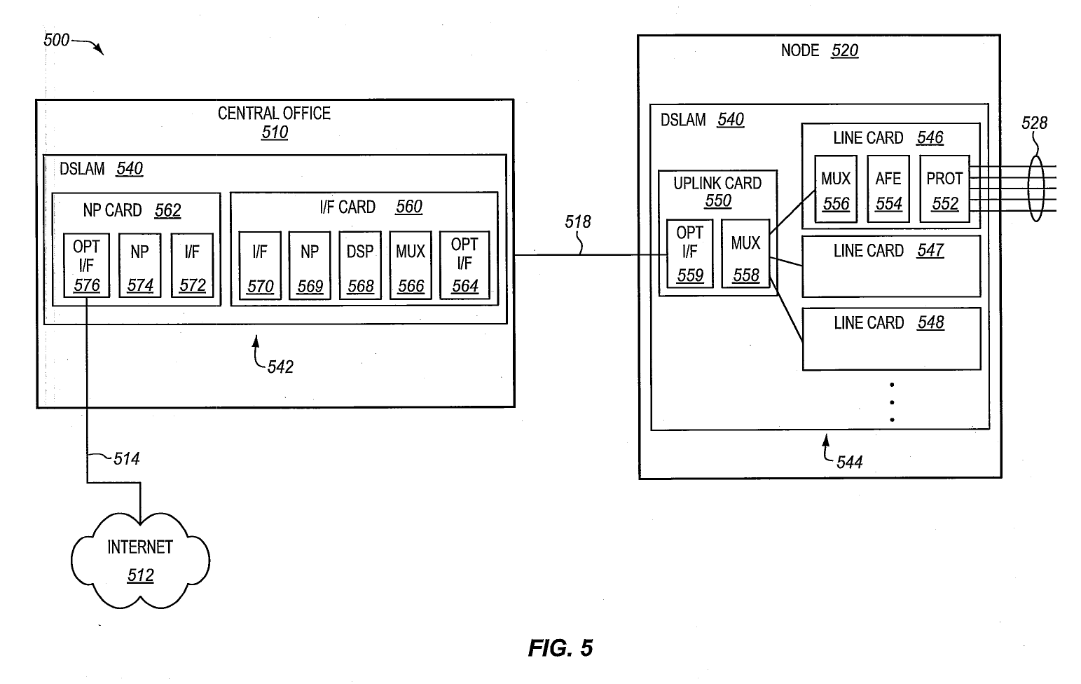

FIG. 5 illustrates an FTTN DSL network 500 in an exemplary embodiment of the invention. DSL network 500 is illustrated as including a central office 510 and a distributed node 520. In an actual implementation, DSL network 500 will include multiple distributed nodes 520 connected to central office 510, but FIG. 5 has been simplified for the sake of brevity. Central office 510 is coupled to distributed node 520 over an optical fiber 518 and is coupled to the internet 512 over an optical fiber 514. Distributed node 520 is coupled to a plurality of customers (not shown) over local loops 528.

DSL network 500 implements a distributed DSLAM 540 where a first portion 542 of DSLAM 540 is installed in central office 510 and a second portion 544 of DSLAM 540 is installed in distributed node 520. In this embodiment, the second portion 544 of distributed DSLAM 540 that is installed in distributed node 520 includes a plurality of line cards 546-548 connected to an uplink card 550. The line cards 546-548 each connect to a plurality of local loops 528 to serve a plurality of customers. Uplink card 550 connects to optical fiber 518.

The components of line card 546 are illustrated in FIG. 5, and line cards 547-548 have similar configurations. Line card 546 includes protection components (PROT) 552 that are adapted to protect the line card 546 from voltage spikes, such as from lightning, inadvertent contact with power cables, etc. Line card 546 also includes analog front end (AFE) components 554 that are adapted to provide analog to digital conversion for signals coming from the customer (upstream), and to provide digital to analog conversion for signals going to the customer (downstream). Line card 546 also includes multiplexer components (MUX) 556 adapted to multiplex digital signals from multiple customers (upstream), and demultiplex digital signals received from uplink card 550 (downstream).

Uplink card 550 includes multiplexer components (MUX) 558 adapted to multiplex digital signals from multiple line cards 546-548 (upstream), and demultiplex digital signals being sent to the multiple line cards 546-548 (downstream). Uplink card 550 also includes optical interface components (OPT I/F) 559 adapted to interface uplink card 550 to optical fiber 518.

Further in this embodiment, the first portion 542 of distributed DSLAM 540 that is installed in central office 510 includes an interface (I/F) card 560 connected to a network processor (NP) card 562. There may be multiple interface cards 560 attached to network processor card 562 that are not shown for the sake of brevity. Interface card 560 includes optical interface components (OPT I/F) 564 adapted to interface with optical fiber 518. Interface card 560 also includes multiplexer components (MUX) 566 adapted to multiplex downstream digital signals and demultiplex upstream digital signals. Interface card 560 also includes digital signal processing (DSP) components 568 that are adapted to provide any type of desired signal processing to the downstream digital signals or upstream digital signals. For instance, the digital signal processing may include compression/decompression of the digital signals, interpolation/decimation, QAM modulation/demodulation, framing such as FEC and interleaving, Layer 2 framing such as ATM or Ethernet, etc. Interface card 560 also includes a network processor (NP) 569 that is adapted to receive downstream packets and convert the packets to digital signals that are processed by the DSP components 568. Network processor 569 may also receive digital signals from the DSP components 568 and packetize the digital signals in a protocol used to transmit the packets. Network processor 569 may provide any lower layer (OSI model) packet processing for digital signals or packets in interface card 560. Interface card 560 also includes interface (I/F) components 570 that connect interface card 560 to network processor card 562.

Network processor card 562 includes corresponding interface components (I/F) 572 that communicate with interface components 570. Network processor card 562 also includes a network processor 574 that is adapted to provide any desired Layer 2 and Layer 3 packet/cell processing, such as prioritizing packets, doling out packets to the different interface cards 560, etc. Network processor card 562 also includes optical interface components (OPT I/F) 576 adapted to interface network processor card 562 with optical fiber 514. Those skilled in the art understand that some components in the first portion 542 of the DSLAM 540 may be integrated. Similarly, some components in the second portion 544 of the DSLAM 540 may be integrated. As an example, network processor 574 and network processor 569 may be integrated in a single processor, but multiple processors are shown for one possible embodiment.

MUX pairs 558 and 566 could be used to provide statistical multiplexing. With statistical multiplexing, each digital signal is assigned a time slot according to priority and need rather than arbitrarily assigning a time slot to each digital signal. Statistical multiplexing is an “on-demand” service rather than one that pre-allocates resources for a transmission link. MUX 558 and 566 may monitor or acquire bandwidth need statistics in assigning time slots for digital signals.

For DSLAM 540, the DSP components 568 (e.g., DSP processors and/or associated memory) and network processors 574 and 569 have traditionally been the most frequently upgraded components. Thus, these components are installed in the central office 510. At the same time, the AFE components 554 have traditionally been less frequently upgraded. Thus, these components are installed in the distributed node 520. When upgrades are needed or desired in the DSP components 568 or network processors 574 and 569, truck rolls to multiple distributed nodes 520 are not needed as the upgrade can be performed at the central office 510. Upgrades in AFE components 554 are hopefully infrequent which significantly reduces the number of truck rolls.

Although specific embodiments were described herein, the scope of the invention is not limited to those specific embodiments. The scope of the invention is defined by the following claims and any equivalents thereof.

We claim:

1. A distributed DSLAM for a DSL network, the distributed DSLAM comprising:
digital signal processing components of the distributed DSLAM implemented in a centralized system on the DSL network;
digital/analog conversion components of the distributed DSLAM implemented in a distributed node on the DSL network that is remote from the centralized system; and
a spanned communication link between the digital signal processing components and the digital/analog conversion components.

2. The distributed DSLAM of claim 1 further comprising:
packet processing components of the distributed DSLAM implemented in the centralized system.

3. The distributed DSLAM of claim 2 wherein the packet processing components include a network processor.

4. The distributed DSLAM of claim 1 wherein the digital/analog conversion components include Analog Front End (AFE) components.

5. The distributed DSLAM of claim 1 wherein the spanned communication link comprises a span of optical fiber and wherein the DSL network comprises a Fiber to the Neighborhood (FTTN) network.

6. The distributed DSLAM of claim 1 wherein the digital signal processing components comprise a pool of digital signal processor (DSP) resources, wherein the DSP resources are allocated to DSL lines based on the processing needs of the DSL lines.

7. The distributed DSLAM of claim 1 wherein the digital signal processing components comprise digital signal processor (DSP) resources having different processing power and/or different memory capabilities, wherein the DSP resources with higher processing power and/or higher memory capabilities are allocated to higher bandwidth DSL lines and the DSP resources with lower processing power and/or lower memory capabilities are allocated to lower bandwidth DSL lines.

8. The distributed DSLAM of claim 1 wherein the centralized system comprises a central office.

9. A method of implementing a distributed DSLAM for a DSL network, the method comprising:
installing digital signal processing components of the distributed DSLAM in a centralized system on the DSL network;
installing digital/analog conversion components of the distributed DSLAM in a distributed node on the DSL network that is remote from the centralized system; and
installing a spanned communication link between the digital signal processing components and the digital/analog conversion components.

10. The method of claim 9 further comprising:
installing packet processing components of the distributed DSLAM in the centralized system.

11. The method of claim 10 wherein the packet processing components include a network processor.

12. The method of claim 9 wherein the digital/analog conversion components include Analog Front End (AFE) components.

13. The method of claim 9 wherein the spanned communication link comprises a span of optical fiber and wherein the DSL network comprises a Fiber to the Neighborhood (FTTN) network.

14. The method of claim 9 wherein the digital signal processing components comprise a pool of digital signal processor (DSP) resources, wherein the method further comprises:
allocating the DSP resources to DSL lines based on the processing needs of the DSL lines.

15. The method of claim 9 wherein the digital signal processing components comprise digital signal processor (DSP) resources having different processing power and/or different memory capabilities, wherein the method further comprises:
allocating the DSP resources with higher processing power and/or higher memory capabilities to higher bandwidth DSL lines; and
allocating the DSP resources with lower processing power and/or lower memory capabilities to lower bandwidth DSL lines.

16. The method of claim 9 wherein the centralized system comprises a central office.

17. A distributed DSLAM for a DSL network, the distributed DSLAM comprising:
first DSLAM components implemented in a centralized system on the DSL network; and
second DSLAM components implemented in a distributed node on the DSL network that is remote from the centralized system;
wherein the first DSLAM components in the centralized system are more likely to be upgraded than the second DSLAM components in the distributed node.

18. The distributed DSLAM of claim 17 wherein the second DSLAM components comprise digital/analog conversion components.

19. The distributed DSLAM of claim 17 wherein the first DSLAM components include digital signal processing components and/or the first DSLAM components include network processors adapted to provide packet processing.

20. The distributed DSLAM of claim 17 wherein:
the first DSLAM components include a plurality of line cards connected to an uplink card having a first multiplexer adapted to demultiplex downstream digital signals being transmitted to the plurality of line cards and to multiplex upstream digital signals received from the plurality of line cards;
the second DSLAM components include at least one interface card and a network processor card, wherein the at least one interface card includes a second multiplexer adapted to multiplex downstream digital signals and to demultiplex upstream digital signals; and
the first multiplexer and the second multiplexer use statistical multiplexing.
